(19) United States
(12) Patent Application Publication
(10) Pub. No.: US 2003/0150522 A1
(43) Pub. Date: Aug. 14, 2003

(54) Process for producing woody composite material

(76) Inventors: Toshiyuki Suzuki, Kyoto (JP); Koji Matsumoto, Kyoto (JP)

Correspondence Address: CONNOLLY BOVE LODGE & HUTZ LLP, SUITE 800, 1990 M STREET NW, WASHINGTON, DC, 20036-3425, US

(21) Appl. No.: 10/260,285

(22) Filed: Oct. 1, 2002

(30) Foreign Application Priority Data
Feb. 13, 2002 (JP) 2002-35618

(51) Int. Cl. B27M 1/02; B27M 1/00; B32B 5/12

(52) U.S. Cl. 144/361; 144/380; 428/107

(57) ABSTRACT

The object of the invention is to provide a process for producing a woody composite material having strength endurable for use as a structural material, even when using short woody chips of 15 cm or less in length.

This invention relates to a process for producing a woody composite material

which comprises the steps comprising

blending woody chips of 1 to 15 cm in length with a binder,

piling up the woody chips so as to be oriented in the longitudinal direction thereof to form a mat, and

pressurizing and heating the mat from a direction perpendicular to both the longitudinal direction and vertical direction of the woody chips.

### TECHNICAL FIELD

This invention relates to a process for producing a woody composite material having strength endurable for use as a structural material, even when using short woody chips of 15 cm or less in length.

### PRIOR ART

It is known that woody composite materials are obtained by piling up intimate mixtures of thin woody chips and a binder arranged in the longitudinal direction of the woody chips, pressurizing and heating the laminate (Japanese Kokoku Publication Sho-50-17512, etc.) or by forming a mat of woody chips piled up in the longitudinal direction, pressurizing and heating the mat (Japanese Patent No. 2527761).

In the woody composite material produced in this manner, woody chips having at least a certain length in the longitudinal direction, i.e. the fiber direction, should be used to endow the composite material with strength necessary for use as a structural material, and woody chips having a length of more than 15 cm in the fiber direction are used in a process described in above Japanese Kokoku Publication Sho-50-17512. In this prior art process, short woody chips cannot be used because the resultant woody composite material is poor in strength.

However, relatively long woody chips used in the conventional processes are hardly obtainable from wood wastes regarded controversial in recent years. That is, wood wasters contain scraps generated in factories or house-construction fields, pallet material wastes disposed of after transportation of components, and dismantled scraps generated in taking down buildings, and these wastes are dry and mixed with foreign matter, and thus easily damaged with a cutting knife, and long woody chips are hardly stably obtainable from such wood wastes.

The length of woody chips obtained by means of a crusher highly resistant to foreign matter, which is used in crushing woodwastes, is about 1 to 15 cm. Thus, the process for producing a woody composite material requiring woody chips having a length of more than 15 cm in the fiber direction, as described in above Japanese Kokoku Publication Sho-50-17512, hardly produces a woody composite material having strength durable as a structural material from wood wastes.

Conventionally, an orientation-laminating machine such as disk orienter for regulating the directions of dropping woody chips has been used as a device for producing woody composite materials. The directions of woody chips can be regulated by passing the dropping woody chips through a large number of slits arranged at regular intervals on the disk orienter, and the interval between the slits is set to be larger than the maximum width and thickness of the woody chips, thus permitting the woody chips having usual width and thickness to pass through the slits but causing their direction to be easily deviated. Further, as the length of the woody chips is decreased, the deviated angle is easily increased. Accordingly, the direction of the woody chips obtained from the wood wastes is easily deviated.

As shown in FIG. 5, the directions of the woody chips tend to be deviated toward a direction (y direction) which is parallel to the horizontal plane (xy plane) in lamination and simultaneously perpendicular to the longitudinal direction of the woody chips, i.e. the orientation direction (x direction). The deviated direction leads to a reduction in reinforcement action, occurrence of voids bv confounding of woody chips, and buckling destruction in compression molding, all of which cause a reduction in the strength of the resultant woody composite material.

### SUMMARY OF THE INVENTION

In view of the present circumstances descried above, the present invention has an object to provide a process for producing a woody composite material having strength endurable for use as a structural material, even when using short woody chips of 15 cm or less in length.

This invention relates to a process for producing a woody composite material from woody chips and a binder.

The first aspect of the invention relates to a process for producing a woody composite material

which comprises the steps comprising

blending woody chips of 1 to 15 cm in length with a binder,

piling up the woody chips so as to be oriented in the longitudinal direction thereof to form a mat, and

pressurizing and heating the mat from a direction perpendicular to both the longitudinal direction and vertical direction of the woody chips.

The second aspect of the invention relates to a process for producing a woody composite material

which comprises the steps comprising

blending woody chips of 1 to 15 cm in length with a binder,

piling up the woody chips so as to be oriented in the longitudinal direction thereof to form a mat, and

rotating the mat by 90° rightward or leftward in the longitudinal direction of the woody chips as the axis of rotation and then pressurizing and heating the mat from the vertical direction.

The third aspect of the invention relates to a process for producing a woody composite material

which comprises the steps comprising

blending woody chips of 1 to 15 cm in length with a binder,

piling up the woody chips to a predetermined height while orienting them in the longitudinal direction thereof in the inside of a guide arranged so as to regulate the outside of the woody chips in a direction perpendicular to both of the longitudinal direction and vertical direction of the woody chips, to form a mat, and

removing the guide and then pressurizing and heating the mat from the vertical direction.

In the third aspect of the invention, the guide is preferably divided by plates into 2 or more regions.

The fourth aspect of the invention relates to a process for producing a woody composite material

which comprises the steps comprising

blending woody chips of 1 to 15 cm in length with a binder,

piling up the woody chips so as to be oriented in the longitudinal direction thereof to form a mat,

pinching the mat with 2 movable plates from a direction perpendicular to both the longitudinal direction and vertical direction of the woody chips and then pressurizing the mat with the plates while pushing the woody chips upward, to reduce the area of the mat observed from the vertical direction, and

pressurizing and heating, from the vertical direction, the mat of which area was reduced when observed from the vertical direction.

The fifth aspect of the invention relates to a process for producing a woody composite material

which comprises the steps comprising

blending woody chips of 1 to 15 cm in length with a binder,

piling up the woody chips so as to be oriented in the longitudinal direction thereof to form a mat, and

passing the mat through 2 plates having a decreasing space therebetween toward the direction of movement while pushing the woody chips upward, to reduce the area of the mat observed from the vertical direction, and

pressurizing and heating, from the vertical direction, the mat of which area was reduced when observed in the vertical direction.

In the fourth and fifth aspect of the invention, it is preferable that the woody chips are piled up so as to be oriented in the longitudinal direction thereof by passing the woody chips through grooves in an orientating plate having the grooves formed thereon.

### BRIEF DESCRIPTION OF THE DRAWINGS

FIG. 1 is a drawing showing a method of piling up woody chips so as to be oriented in the longitudinal direction thereof by dividing plates.

FIG. 2 is a drawing showing a method of piling up woody chips so as to be oriented in the longitudinal direction thereof by a disk orienter.

FIG. 3 is a drawing showing a method of piling up woody chips so as to be oriented in the longitudinal direction thereof by a chute.

FIG. 4 is a typical diagram illustrating a method of piling up woody chips so as to be oriented in the longitudinal direction thereof by an orientating plate having grooves formed thereon

FIG. 5 is a typical diagram illustrating a deviated direction of the longitudinal direction of the woody chips, i.e. of the direction of orientation.

FIG. 6 is a typical diagram illustrating one embodiment of each step in the first aspect of the invention.

FIG. 7 is a typical diagram illustrating one embodiment of the mat-forming step to the pressurizing and heating step in the process for producing the woody composite material wherein the mat is formed by use of a guide.

FIG. 8 is a typical diagrams illustrating one embodiment from the mat-forming step to the pressurizing and heating step in the process for producing the woody composite material wherein the guide is divided by plates.

FIG. 9 is a typical diagram illustrating a section of mat 51 obtained by using the guide 81 provided with dividing plates, the section being cut perpendicularly to the direction of the line.

FIG. 10 is a typical diagram illustrating the one embodiment of each step in the second aspect of the invention.

FIG. 11 is a drawing showing the process for producing woody chips having a binder adhering thereto in the third aspect of the invention.

FIG. 12 is a drawing illustrating each step as post-process in FIG. 11.

FIG. 13 is a typical diagram of one embodiment of each step in the third aspect of the invention.

FIG. 14 is a sectional view of a hopper and a guide in a direction perpendicular to the direction of the line in FIG. 13.

FIG. 15 is a drawing showing a method wherein the area of the mat observed from the vertical direction is reduced by pressurizing the mat after pinched between 2 movable plates.

FIG. 16 is a drawing showing a method wherein the area of the mat observed from the vertical direction is reduced by passing the mat through 2 plates having a decreasing space therebetween toward the direction of movement.

FIG. 17 is a typical diagrams illustrating one embodiment of each step in a conventional process for producing a woody composite material.

FIG. 18 is a drawing showing the process for producing a woody composite material in Test Example 12.

### EXPLANATIONS OF LETTERS OR NUMERALS

1: woody chips

2: drum blender

3: disk orienter

4: woody chips to which an binder adheres

5: mat

51: mat

51a, 51b, 51c, 51d, 51e: each block of mat

5′: mat obtained in the prior art

6: horizontal pressurizing/heating pressing unit

6′: vertical pressurizing/heating pressing unit

7: woody composite material

71: woody composite material

7′: woody composite material obtained in the prior art

8: guide

81: guide equipped with dividing plates

9: moving stage

10: belt conveyer

F: direction along which the moving stage moves in the mat-forming step

P: pressurizing direction in the pressurizing and heating step

21b: woody chips

21c: woody chips to which an binder adheres

21d: mat

25: binder

26: belt conveyer

261: receiver

27: guide

271: dividing plates

272: divided portions

29: hopper

291: introducing opening

292: discharging opening

31: woody chips

32: belt conveyer

33: dividing plates

34: disk orienter

35: chute

36: orientating plate having grooves formed thereon

37: mat

38: plate

### DETAILED DESCLOSURE OF THE INVENTION

Hereinafter, this invention is described in more detail.

This invention relates to a process for producing a woody composite material from woody chips and a binder.

In any modes of the process for producing a woody composite material according to this invention, woody chips of 1 to 15 cm in length are first blended with a binder.

As the woody chips described above, those made of plant materials can be widely used, and examples thereof include those made of coniferous trees such as cedar, Japanese cypress, spruce, fir, and radiata pine; broadleaf trees such as white birch, apitong, kamerere, sengon laut and aspen; and bamboo, kaoliang, etc.

The form of the starting material of the woody chips is not particularly restricted but includes raw materials such as log, thinning wood, etc., scraps generated in factories or house-construction fields, pallet material wastes disposed of after transportation of components, and dismantled scraps generated in taking down buildings.

The method of crushing the starting material in the form described above into woody chips is not particularly restricted, but includes there is a method of cutting veneered materials with a rotary cutter into chopstick-shaped sticks, a method of cutting a log with a rotating cutter in a flaker into strands, and a method of crushing wood by rotating a roll provided thereon with a cutter in a uniaxial crusher.

The crushed starting material is used as the woody chips preferably after classification by use of a classifying machine capable of classifying it into woody chips having thickness in a predetermined range.

The means of classifying the crushed starting material is not particularly restricted, but includes a classifying machine in a wave roller system capable of continuous classification on the basis of chip thickness.

Out of the woody chips thus classified, those of 1 to 15 cm in length are used in this invention to produce the woody composite material. If the length of the chips is less than 1 cm, the resultant woody composite material cannot attain sufficient strength as a structural material, while chips of more than 15 mm in length are hardly obtainable from recycled materials as the starting material. The length is more preferably 1 to 8 cm, more preferably 1 to 6 cm.

The woody chips of 1 to 15 cm in length need not to be fully made of crushed chips, and when content of the crushed chips is at least 80% by weight, preferably at least 90% by weight, it may be sufficient to express the expected effect.

The thickness of the woody chips used in this invention is preferably 1 to 15 mm, but is not particularly restricted If the thickness is less than 1 mm, the strength of the resultant woody composite material tends to be lowered, while if the thickness exceeds 15 mm, the resulting woody composite material tends to generate voids so that it may lower strength. The thickness is more preferably 1 to 11 mm.

The thickness of the woody chips means a shorter dimension out of dimensions in two axial directions perpendicular to the axis of the longitudinal direction of the woody chips and simultaneously perpendicular to each other, and the width of the woody chips means a longer dimension out of dimensions in two axial directions perpendicular to the axis of the longitudinal direction of the woody chips and simultaneously perpendicular to each other.

Each of the thickness and width of the woody chips is preferably not more than ⅛ of the thickness of the resultant woody composite material, and the length of the woody chips is preferably at least 5 times the width of the woody chips.

The woody chips are preferably those having a water content regulated to be constant. When the water content is constant, the resultant woody composite material is of less dispersed quality. The method of allowing the water content of the woody chips to be kept constant includes a method of leaving the woody chips in an oven at a regulated temperature for a predetermined time. For example, after the woody chips are left in an oven at 50° C. for 24 hours, the water content of the woody chips is kept almost at about 5%.

The water content of the woody chips used in this invention is preferably 0 to 10%. When the water content is higher than 10%, the physical properties of the product maybe deteriorated without achieving sufficient adhesion.

The binder is not particularly restricted insofar as it is an adhesive for use in adhesive-bonding plywood or a particle board in wood industry, and for example, phenol resin, urea resin, isocyanate etc. can be mentioned. These may be used singly or in combination thereof.

The amount of the binder added may be suitably determined depending on the density, shape and surface conditions of the woody chips, but usually the amount of the binder is preferably 1 to 20 parts by weight relative to 100 parts by weight of the woody chips.

The method of blending the woody chips with a binder includes a method of applying a binder onto the woody chips by spraying or the like on a belt conveyer or in a drum blender or the like thereby permitting the binder to adhere to the surfaces of the woody chips. The binder may be in the form of liquid or powder, and when the binder is in the form of liquid, generally the binder is sprayed on the woody chips or mixed under stirring with the woody chips, and the woody chips with the binder adhering thereto are subjected to the next step. On the other hand, when the binder is in the form of powder, generally the binder is mixed uniformly with the woody chips and then subjected to the next step.

In the first aspect of the invention, the woody chips are piled up while being oriented toward the longitudinal direction, to form a mat.

In orienting the woody chips toward the longitudinal direction, a fiber direction of the woody chip is preferably oriented in the angle of less than 20° to the longitudinal direction of the molded woody composite material.

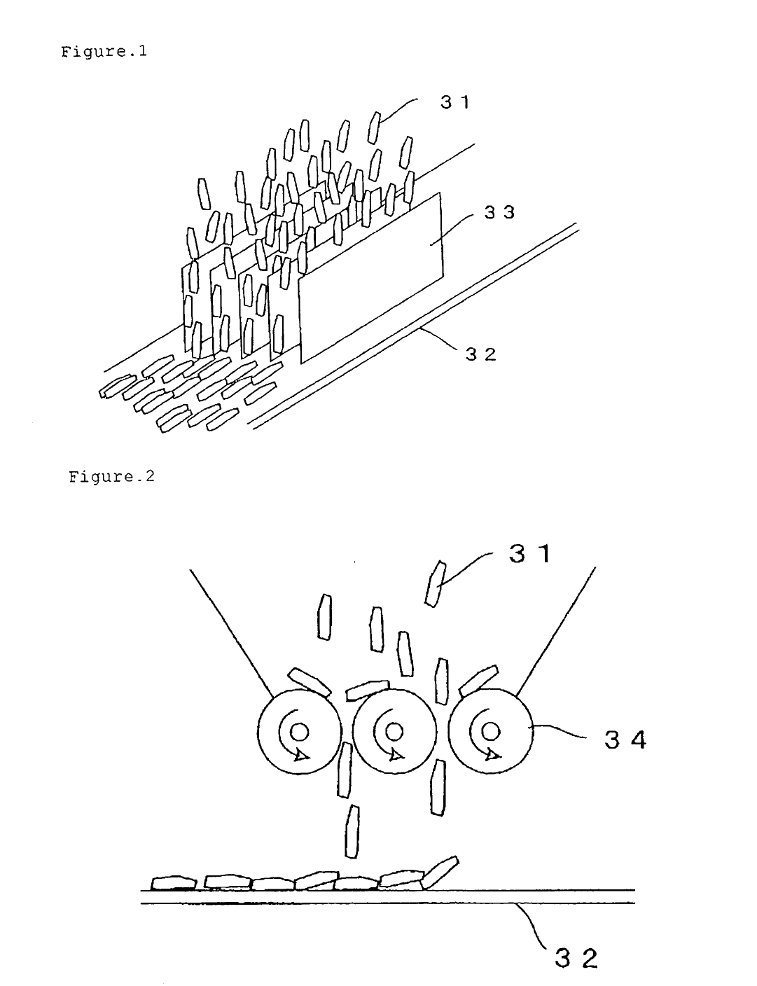

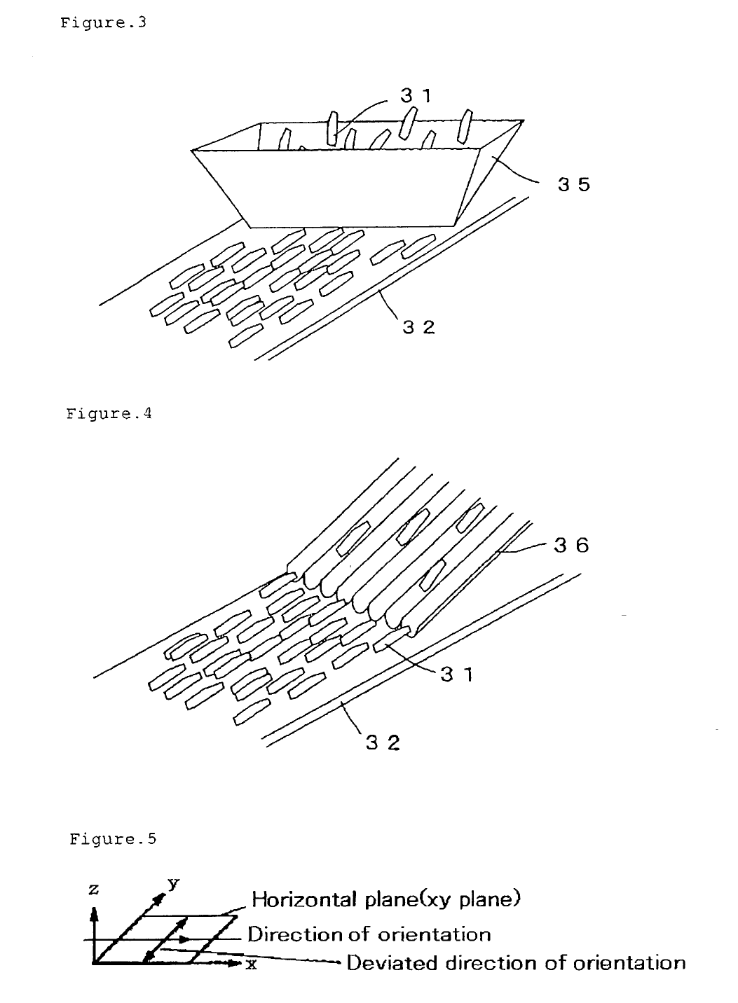

As the method of piling up the woody chips while orienting them in the longitudinal direction, a known method can be suitably used, and for example, a method of using dividing plates as shown in FIG. 1, a method of using a disk orienter as shown in FIG. 2, a method of using a chute as shown in FIG. 3, and a method of using an orientating plate having grooves formed thereon as shown in FIG. 4 are mentioned.

In these devices, the disk orienter is also used in units such as oriented strand board (OSB) etc. in producing conventional woody composite materials, and when the disk orienter is used, the woody chips having passed through the disk orienter are dropped downward on a belt conveyer etc. and piled up with being oriented toward the longitudinal direction to form a mat. The height of the mat thus formed is almost identical with the width of the resultant woody composite material. When the mat is highly piled up for increasing the width of the woody composite material, the mat itself tends to collapse easily, but can be prevented from collapsing by providing both sides of the mat with a guide made of a plate whose height is almost identical to the width of the woody composite material.

The shape of the guide is not particularly restricted insofar as the guide can prevent both sides of the mat from collapsing, but preferably the guide is shaped so as to further prevent the front and rear of the mat from collapsing. As such a guide, a guide in the form of a rectangular parallelepiped made of a metal plate of 1 to 5 mm in thickness whose top and bottom are opened can be readily produced, easily handled, and thus preferably used.

When the woody chips are highly piled up by the disk orienter and guide described above, the orientation of the woody chips dropped from the upper part of the guide is easily disordered at the bottom of the guide. The reason why the orientation is disordered is that by rotation moment received from the disk orienter, by air resistance, by contacting with other woody chips, or the like, individual woody chips are rotated and the time of dropping to the bottom is prolonged, thus failing to maintain the orientation of the woody chips passed through the disk orienter. For preventing the orientation of the woody chips from being disordered at the bottom of the guide, the inside of the guide is preferably divided into 2 or more regions by arranging plates (referred to hereinafter as dividing plates) at regular intervals between the guide, in order to prevent rotation of the dropping woody chips. By arranging such plates, it is possible to secure stabilization of qualities in the upper and lower portions of the resultant woody composite material. The plate is preferably a metal plate having a thickness of 1 to 5 mm, and the plate may be fixed to, or removable from, the body of the guide.

The method of dividing the guide by plates into 2 or more regions is not particularly restricted insofar as a section of the guide divided by the plate, that is, a section of the guide divided in the horizontal direction, is approximately rectangular. Because there is a difference in the strength properties of the woody chips between the longitudinal direction and its perpendicular direction, the direction of dividing the inside of the guide by the plates is suitably determined depending on the desired woody composite material. When the interval between the plates is too small, the woody chips cannot drop accurately into the portions divided by the plates, thus easily causing an obstacle in automatic production, while when the interval between the plates is too long, the woody chips may hardly be oriented in the longitudinal direction, thus failing to secure necessary strength.

When the inside of the guide is divided bv the plates, the classified woody chips fed to the guide have thickness varying depending on the intervals of the dividing plates in the guide. For example, when the interval between the dividing plates in the guide is 2 to 4 cm, the thickness of the woody chips is preferably 1 to 11 mm, and when the interval between the dividing plates is 2 to 3 cm, the thickness of the woody chips is preferably 3 to 5 mm.

For introduction of an intimate mixture of the woody chips and the binder into the guide, a hopper having a (beak-like) internal shape whose width is decreased toward a slit-shaped discharging opening can be used in addition to the disk orienter. When the hopper is used, it is preferable that the discharging opening of the hopper is positioned over the upper openings of the divided portions of the guide divided by the plates, the intimate mixture of the woody chips and the binder is introduced into an inlet in an upper part of the hopper, the woody chips are oriented in the hopper, and then the woody chips are fed through the discharging opening to the divided portions.

By using the said hopper, the intimate mixture of the woody chips and the binder can be fed efficiently to each divided portion of the guide in such a state that the woody chips are oriented toward the longitudinal direction.

The internal shape of the said hopper can be determined suitably depending on the shape of the guide, and may be any shapes which do not cause clogging of the intimate mixture of the woody chips and the binder; for example, the slit width of the discharging opening is preferably 15 mm or more and simultaneously smaller than the inner width of the divided portion of the guide.

In the first aspect of the invention, the mat is finally pressurized and heated from a direction perpendicular to both the longitudinal direction and vertical direction of the woody chips.

Pressurizing and heating may be carried out in either way of heating after pressurizing or way of pressurizing after heating, as well as it may be carried out simultaneously.

The method of pressurizing and heating the mat includes a method of pressuring the woody chips while transmitting heat from the surface to inside of the woody chips by a device such as a heating platen, or a method of directly heating the inside of the woody chips while pressurizing them by steam injection, high-frequency heating or the like. In the method of pressurization and heating, a vertical pressing machine or a continuous pressing machine for molding conventional woody composite materials may be allowed to work in the horizontal direction.

When the upper part is opened upon pressurization of the mat, apart of the pressure applied from the horizontal direction is released upward, so the upper face of the mat is expanded, and as a result, the density of a portion near to the upper face of the mat may be lowered, the orientation of the woody chips may be disordered and the strength of the woody composite material may be lowered. For preventing reduction of the strength of the resultant woody composite material, the upper face of the mat upon pressurization is preferably pressed by a heating platen or the like.

When the mat is pressurized and heated, the formed mat may be pressurized and heated as it is, or the mat which is cut into pieces of predetermined length may be pressurized and heated singly or together and intermittently.

The temperature at which the mat is heated is preferably 100 to 250° C. If the temperature is less than 100° C., the curing time may be too long, while if the temperature is higher than 250° C., the wood may be burned. Further, the pressure at which the mat is pressurized,is preferably 1 to 10 MPa. If the pressure is less than 1 MPa, the mat cannot be sufficiently pressurized and many cavities may remain in the product, while if the pressure is higher than 10 MPa, facilities for pressing are expensive. The pressurization time is determined depending on the relaxation time of repulsion force and the curing time of the binder. The repulsion force means the repulsion force from the mat to the pressurized surface upon compressing the mat to a predetermined density. The relaxation time of the repulsion force is changed depending on various parameters such as the type of wood, shape of woody chips, density of the woody composite material and the heating method, and the curing time of the binder is determined depending on the temperature and the type of binder.

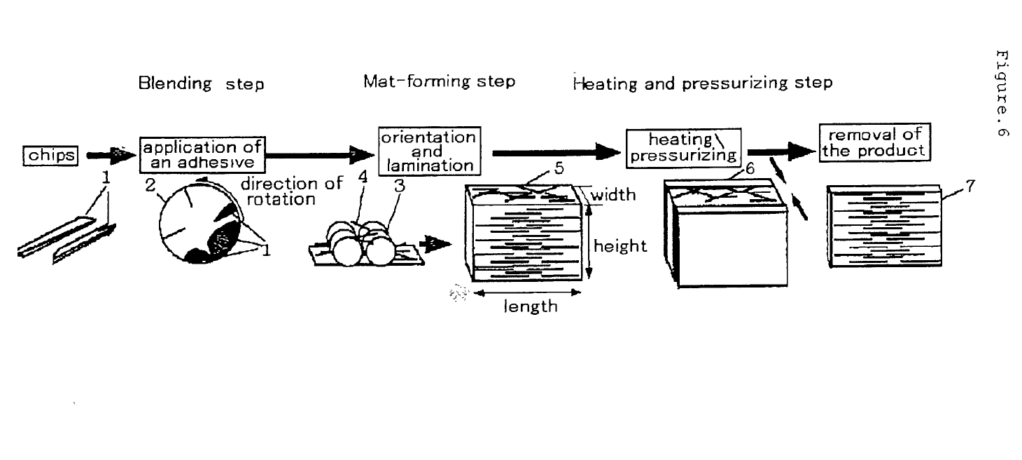

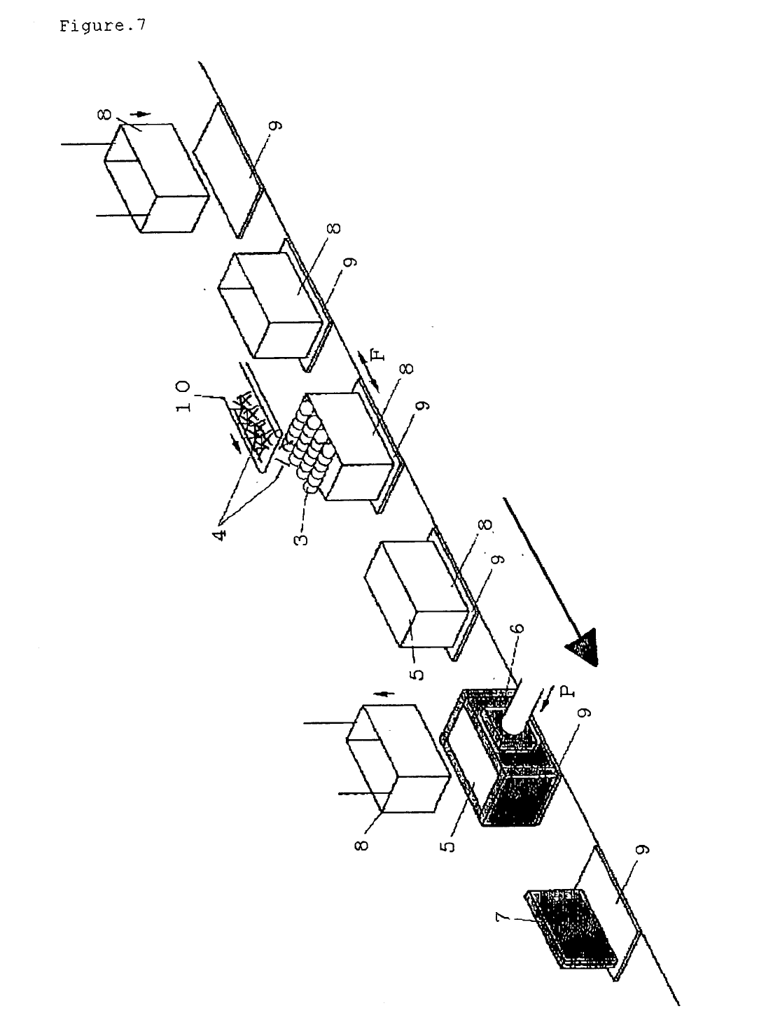

The deviated direction of the longitudinal direction of woody chips, i.e. the direction of orientation of woody chips is shown in FIG. 5. In the pressurizing and heating step, the direction of the woody chips swayed toward the direction of y can be pushed back, and thus the direction of the woody chips swayed upon formation of the mat can be cancelled, and a deterioration in the strength of the resultant woody composite material can be prevented.

When the guide is used in the step of forming the mat, the guide while retaining the mat therein is inserted into a pressing machine, the position of a press plate is adjusted to the guide, and the guide is pulled away upward to remove the whole of the guide, or the body of the guide is left but the plates are removed, and thereby the mat can be subjected to the pressurizing and heating step without deforming the shape of the mat by pressurization with a pressing machine capable of pressurizing and heating. When the laminate of the woody chips collapses upon removal of the plates or the guide, the guide may be provided in advance with a collapse-preventing sheet, and together with the sheet, the mat may be pressurized; for example, a newspaper is spread as the collapse-preventing sheet in the guide, and when the guide is removed, the mat is wrapped with the newspaper, then fixed with a string or an adhesive tape and subjected to pressurization.

After the pressurizing and heating step, the woody composite material is preferably processed by annealing, cutting, sanding, or the like in order to improve the dimension accuracy and surface properties thereof.

FIG. 6 is a drawing typically illustrating each step in one embodiment in the first aspect of the invention. First, in the blending step, woody chips 1 and a binder are introduced into a binder-blending unit such as drum blender 2 and rotated whereby the woody chips are coated with the binder.

In the subsequent step of forming a mat, the woody chips 4 with the binder adhering thereto are dropped onto a disk orienter 3 provided with disks, and the chips are piled up while being oriented toward the longitudinal direction, to form a mat 5. In the subsequent pressurizing and heating step, the mat 5 is pressurized from a direction perpendicular to both the longitudinal direction and vertical direction of the woody chips and heated for a predetermined time by a horizontal pressurizing and heating pressing unit 6, to give a woody composite material 7 having the woody chips integrated at high density therein.

FIG. 7 is a drawing illustrating the typical mat-forming step wherein a guide is used A guide 8 is placed on a moving stage 9 for preventing collapse of the mat 5 and transferred below a disk orienter 3. The woody chips 4 having a binder adhering thereto, supplied from a belt conveyer 10, are oriented in the longitudinal direction by the disk orienter 3 and piled up in the guide 8. The length of generally distributed woody composite materials is usually 3 m or more, and the length of the guide should also be equal to, or greater than, the length of such woody composite materials, while the distance between dropping points of the woody chips and general disk orienter is 1 m or less. In order to piling up the woody chips uniformly in the guide 8, the moving stage 9 is reciprocated in the direction of the line (direction of F) until the woody chips are piled up to the same height as that of the guide 8.

The formed mat 5, together with the guide 8, is set in the horizontal pressurizing and heating pressing unit 6, and a heating platen of the horizontal pressurizing and heating pressing unit 6 is arranged along the outside of the guide 8. The arrangement is confirmed, and when the guide 8 is raised upward by a crane etc., the mat 5 is retained in the horizontal pressurizing and heating pressing unit 6 without deformation. Thereafter, the mat is pressurized and heated for a predetermined time at a predetermined temperature until it attains a predetermined thickness, whereby the woody composite material 7 is obtained.

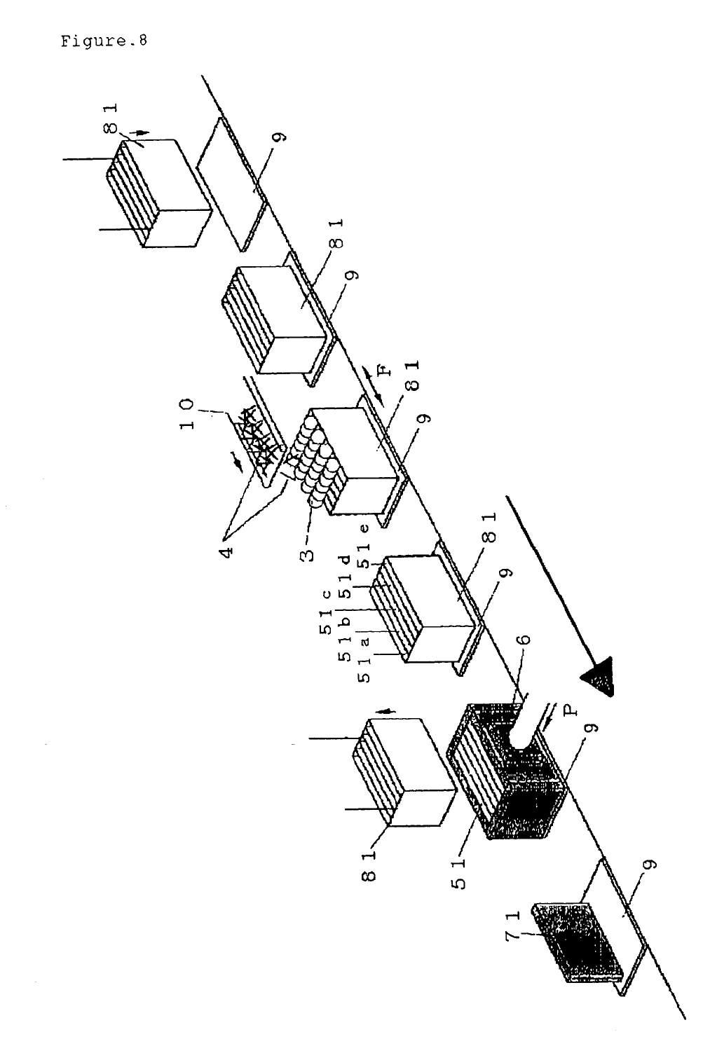

FIG. 8 is a drawing illustrating a typical guide divided by dividing plates into two or more regions. Guide 81 equipped with dividing plates for preventing collapse of the laminate and disorder of the orientation is placed on the moving stage 9 and transferred below the disk orienter 3. The intervals of the dividing plates in the guide 81 are identical with the intervals of the disks in the disk orienter 3, and the dividing plates are adjusted to the positions of the disks such that the woody chips 4 with a binder, dropped from the disk orienter 3, are dropped smoothly between the dividing plates. The woody chips 4 supplied from the belt conveyer 10 are oriented in the longitudinal direction by the disk orienter 3 and piled up in the guide 81. When the dimension of the intended woody composite material is long, the moving stage 9 during lamination is reciprocated in the direction of the line (direction of F) in the similar manner as in FIG. 7.

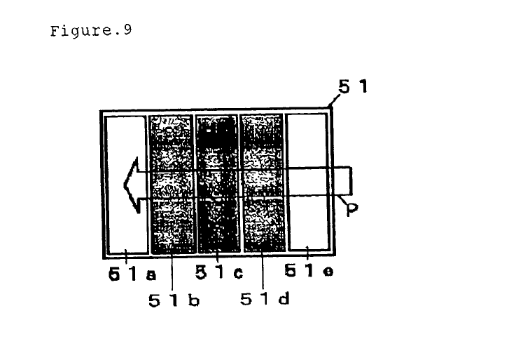

The mat 51 thus formed, together with the guide 81, is set in the horizontal pressurizing and heating pressing unit 6, and a heating platen of the horizontal pressurizing and heating pressing unit 6 is arranged along the outside of the guide 81. The arrangement is confirmed, and when the guide 81 is raised upward by a crane etc., the mat 5 is retained without deformation in the horizontal pressurizing and heating pressing unit 6. Thereafter, the mat is pressurized and heated at a predetermined temperature until it attains a predetermined thickness and retained for a predetermined time. Before pressurization, the mat 51 has gaps between blocks 51a, 51b, 51c, 51d and 51e as shown in FIG. 9, or even if there are not gaps, the laminate is in an incontinuous state. However, the gaps are cancelled by pressurization from the crosswise direction and do not remain as defects in the woody composite material 71.

In the second aspect of the invention, the woody chips are blended with a binder to form a mat in the same manner as in the first aspect of the invention, and then the mat is rotated by 90° rightward or leftward around the longitudinal direction of the woody chips as the axis of rotation and then pressurized and heated from the vertical direction. In the pressurizing and heating step in the second aspect of the invention, the formed mat is cut into pieces having a predetermined length, and the mat while retaining the laminated state thereof is rotated by 90° rightward or leftward around the direction of movement as the axis of orientation in the molding line and then heated by a known molding machine for woody materials while the mat is usually pressurized downward, whereby the woody composite material is obtained. The pressurization and heating in the second aspect of the invention are carried in the same manner as in the first aspect of the invention except that the direction of pressurization is a vertical direction.

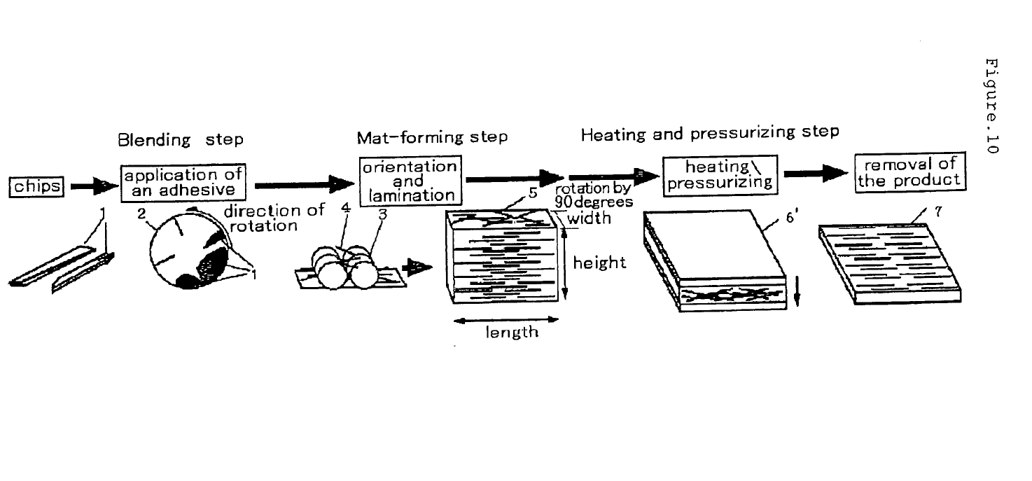

FIG. 10 is a drawing typically illustrating each step in one embodiment in the second aspect of the invention, and this process is the same as that prior to the mat-forming step in the first aspect of the invention. In the pressurizing and heating step, the mat 5 while retaining the laminated state thereof is rotated by 90° rightward around the longitudinal direction of the woody chips as the axis of rotation and then pressurized downward under heating by a vertical pressurizing and heating press 6′, or after pressurization, is heated for a predetermined time, to give a woody composite material 7 having the woody chips integrated at high density therein.

According to the first and second aspects of the invention, the direction of the woody chips swayed toward the direction of y in FIG. 5 is pushed back in the pressurizing and heating step, whereby the direction of the woody chips swayed upon formation of the mat can be cancelled and relaxed, so that a deterioration in the strength of the resultant woody composite material can be prevented. Accordingly, a high-strength woody composite material can be produced even from short woody chips of 15 can or less in length.

In the third aspect of the invention, the woody chips are blended with a binder in the same manner as in the first aspect of the invention and then piled up to a predetermined height while being oriented toward the longitudinal direction in a guide arranged so as to regulate the outside of the woody chips in a direction perpendicular to both the longitudinal direction and vertical direction thereof, to form a mat.

It is necessary that the above-mentioned guide be arranged so as to regulate the outside of the woody chips in a direction perpendicular to both the longitudinal direction and vertical direction thereof, and for example, the same guide as described above is used.

The guide described above is preferably divided by plates into 2 or more regions. Dropping woody chips supplied from the disk orienter can thereby be prevented from being rotated, thus easily regulating the direction of orientation. For example, when a plate-shaped woody composite material of 1000×500×30 mm is produced, it is preferable that a guide body of 1000×500×100 mm in size and 19 plates of 100 mm in height are prepared, and the width (i.e. 500 mm) of the guide body is divided by the plates at regular intervals of 20 mm.

In the third aspect of the invention, the guide is then removed, and the mat is pressurized and heated from the vertical direction. The pressurization and heating in the third aspect of the invention are carried out in the same manner as in the first aspect of the invention except that the direction of pressurization is a vertical direction.

For pressurization of the mat, there is a method of pressurizing the mat from the horizontal direction thereof, that is, from a direction perpendicular to the direction of lamination or a method of pressurizing the mat from the vertical direction thereof, that is, from the direction of lamination. The method of pressurizing the mat from the horizontal direction thereof includes a method of pressurizing the mat in a laminated state by a press plate working in the horizontal direction and a method of rotating the mat by 90° and pressurizing it by a press plate working in the vertical direction. In the method of pressurizing the mat in a laminated state by a press plate working in the horizontal direction, the loading of the press plate is weighed perpendicularly on a shaft of a cylinder rod actuating the press plate, thus swaying the press plate to make it difficult to regulate pressurization. In particular, when a long woody composite material is produced, it is difficult to regulate pressurization. On one hand, in the method of rotating the mat by 90° and then pressurizing it by a press plate working in the vertical direction, the orientation may be deviated upon rotation, and a device for rotating the mat should be additionally arranged to increase the cost of facilities.

In the third aspect of the invention, however, the mat is pressurized from the vertical direction thereof, that is, from the direction of lamination, and thus the pressing machine is installed so as to work in the vertical direction, and the production process can be simplified to reduce the production cost.

The size of the guide is not particularly restricted, and may be suitably determined depending on the desired woody composite material; for example, when a plate-shaped woody composite material of 1000×500×30 mm is produced, a mat formed in the guide should be 1000×500×100 mm in size. Accordingly, it is preferable that the length and width dimensions of the inside of the guide are equal to, or slightly larger than, the length and width of the desired woody composite material, while the height of the inside of the guide is at least 3 times that of the desired woody composite material.

The pressurization and heating in the third aspect of the invention is conducted preferably after at least the plates dividing the inside of the guide are removed.

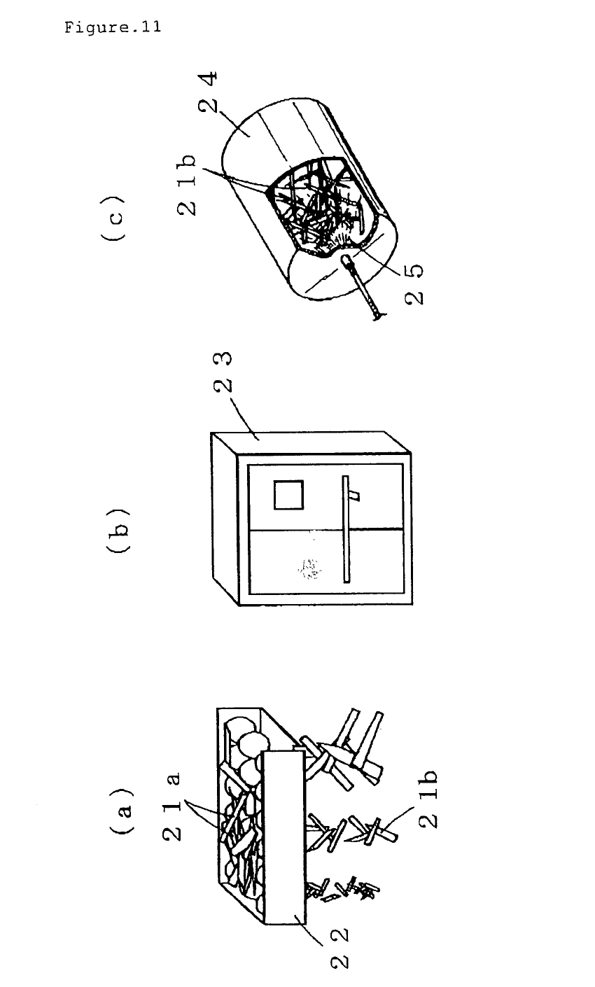

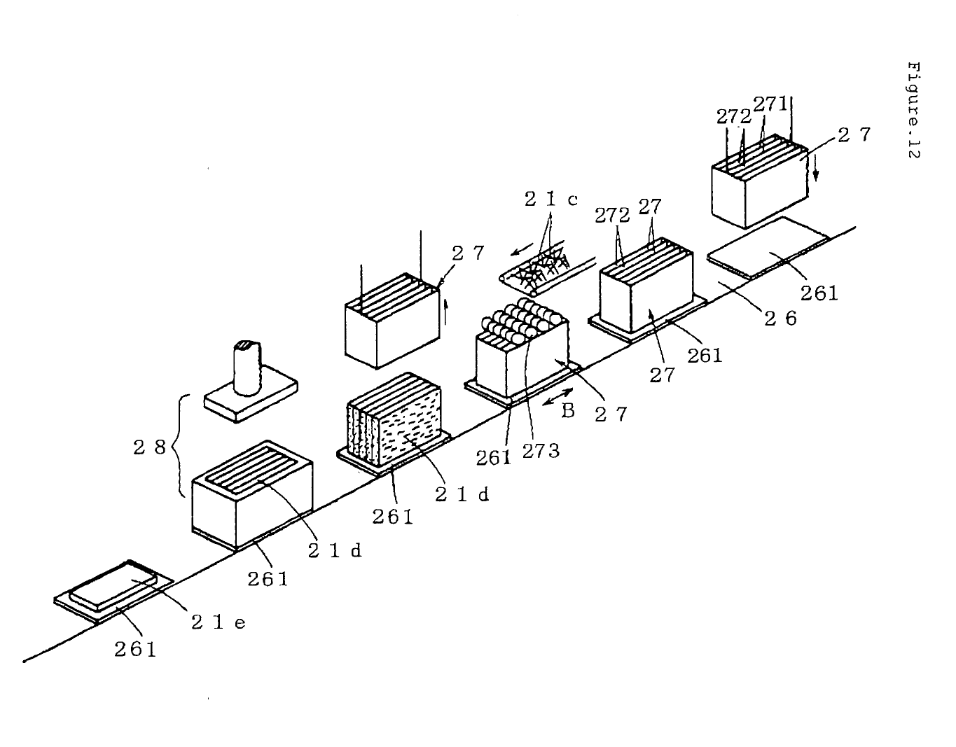

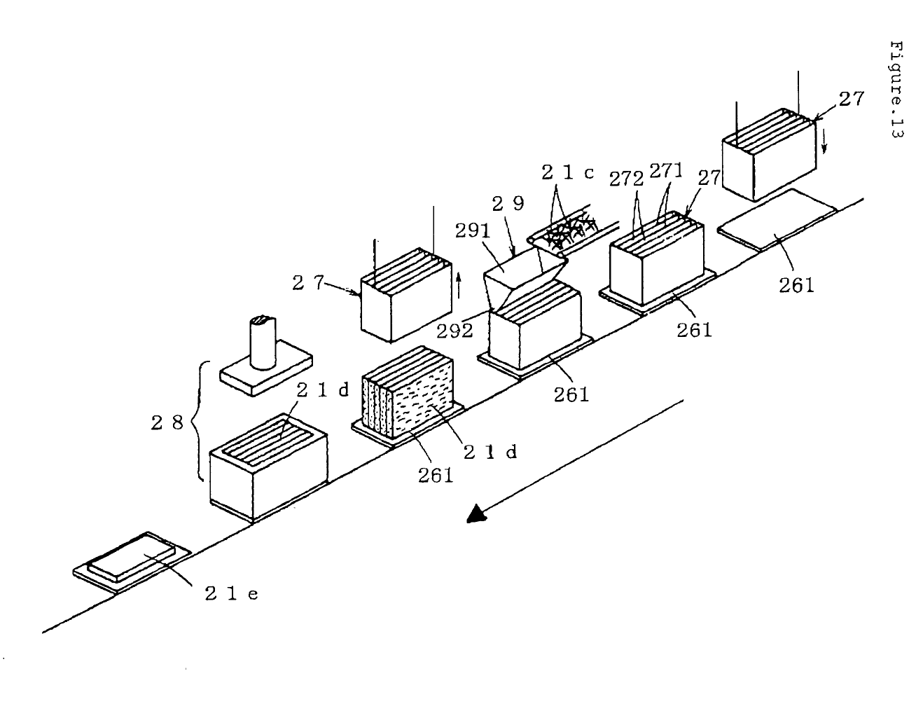

FIGS. 11 and 12 are drawings showing one embodiment of the third aspect of the invention. As shown in FIG. 11(a), woody chips 21a obtained by crushing or cutting with a crusher, a cutting machine or the like not shown in the drawing are classified by a classifier 22 in a wave roller system to give woody chips 21b of 1 to 1.5 mm in thickness Then, as shown in FIG. 11(b), the woody chips 21b are introduced into a drying oven 23 and dried to water content of 0 to 10%.

As shown in FIG. 11(c), the dried woody chips 21b are introduced into a drum blender 24, and the woody chips 21b in the drum blender 24 are sprayed with a binder 25, to allow the binder 25 to adhere to the woody chips 21b in the drum blender 24, where by the woody chips 21c having the binder adhering thereto are obtained. As shown in FIG. 12, a guide 27 divided by dividing plates 271 into a plurality of divided portions 272 is placed on a receiver 261 on a belt conveyer 26, and then the guide 27 is transferred to a predetermined position below the disk orienter 273.

When the guide 27 is transferred to the predetermined position below the disk orienter 273, the woody chips 21c with a binder are introduced downward into the disk orienter 273, and while the longitudinal direction of the woody chips 21b is oriented in the longitudinal direction of the divided portions 272 by the disk orienter 273, the woody chips 21c with a binder are introduced to each of the divided portions 272. At the same time, the guide 27 is reciprocated in the direction of transfer of the belt conveyer 26 (arrowed directions of B in FIG. 12) such that the woody chips 21c with a binder can be introduced uniformly in the longitudinal direction of the divided portions 272.

Then, the woody chips 21c with a binder are piled up to a predetermined height in the guide 27, then the guide 27 is removed by raising it upward, the mat 21d having the woody chips 21b laminated therein is transferred by the belt conveyer 26 to a pressing machine 28, and the mat 21d is heated by the pressing machine 28 and simultaneously press-molded to attain an intended thickness of the woody composite material from the direction of lamination of the woody chips 21b, that is, from the vertical direction.

Thereafter, the mat is processed by annealing, cutting or sanding if necessary to give a woody composite material 21e. In this embodiment, the woody chips 21c with a binder are oriented and fed to the guide 27 as described above, and since the inside of the guide 27 is divided into the divided portions 272 having a section with narrow width in an approximately rectangular form, the woody chips 21c with a binder, introduced into the guide 27, are regulated by the dividing plates 271 in the divided portions 272, so that the woody chips 21b even having a short and irregular fiber length can be oriented very uniformly and homogenously, and simultaneously laminated into a mat reliably without deformation in a state oriented along the longitudinal direction of the divided portions 272.

By pressurizing the mat 21d into a woody composite material, a woody composite material having strength enough to be usable as a structural material can be produced from short woody chips of 15 cm or less in length.

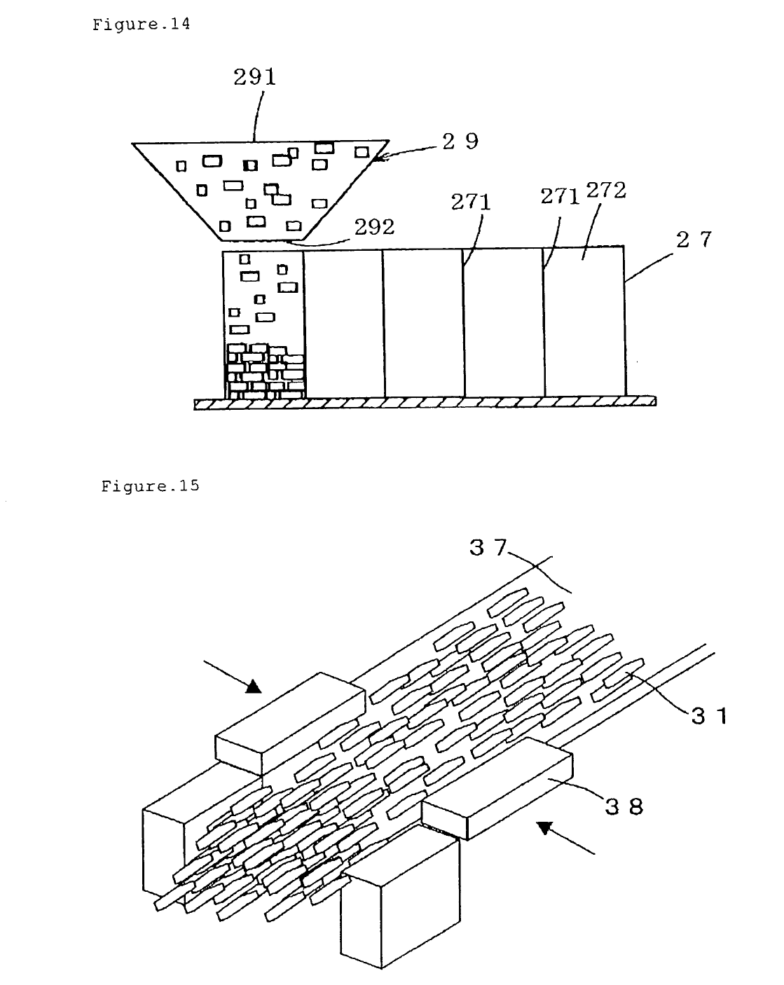

FIGS. 13 and 14 are drawings showing another embodiment of the third aspect of the invention. This embodiment is the same as in FIGS. 11 and 12 except that the woody chips 21c having a binder adhering thereto are fed to the guide 27 via a hopper 29 in place of the disk orienter 273.

That is, in this embodiment, the hopper 29 is provided with an introducing opening 291 in the upper part and a slit-shaped discharging opening 292 in the lower part, has an internal shape whose width is decreased from the introducing opening 291 to the discharging opening 292, and can be transferred horizontally to sub-grooves perpendicular to the direction of movement of the belt conveyer 26. When the guide 27 is transferred by the belt conveyer 2 6 to a predetermined position below the hopper 29, the hopper 29 is arranged such that its discharging opening 292 faces one of the divided portions 272 which is positioned in one edge, in the width direction, of the guide 27, and the woody chips 21c with a binder are fed via the hopper 29 into the divided portion 272, and after a necessary amount of the woody chips 21c with a binder are fed to one of the divided portions 272, the hopper 29 is slided horizontally to a predetermined position above the adjacent divided portion 272, to supply the woody chips in the same manner, and a necessary amount of the woody chips 21c with a binder are thus fed to all the divided portions 272.

According to this embodiment, the woody chips 21c with a binder can be fed uniformly via hopper 29 to the respective divided portions, thus providing a woody composite material that is denser and excellent in strength.

In addition to the embodiment of the third aspect of the invention shown in the drawings, a plurality of hoppers can be arranged in the width direction so as to permit the woody chips to be fed simultaneously to a plurality of divided portions, and the dividing plates may be raised, while the guide body may be dismantled and removed.

According to the third aspect of the invention, a mat having woody chips oriented highly accurately in the longitudinal direction can be obtained by molding the mat with a guide, and accordingly, a high-strength woody composite material can also be obtained by pressurization from the vertical direction with a simpler production unit.

In the fourth aspect of the invention, the woody chips are blended with a binder to form a mat in the same manner as in the first aspect of the invention, and then the mat is pinched between 2 movable plates from a direction perpendicular to both the longitudinal direction and vertical direction of the woody chips, and while the woody chips are pushed upward, the area of the mat observed from the vertical direction is reduced.

FIG. 15 is a drawing showing a method wherein the area of a mat observed from the vertical direction is reduced by pressurizing the mat with 2 movable plates. By pressurizing the mat 37 with 2 movable plates 38, the bottom area of the mat is reduced and the pressure applied is released upward to the opening, thus pushing the woody chips 31 upward.

By pressurizing the mat in this manner, the woody chips in the mat tends to be oriented along the longitudinal direction, and defects conventionally occurring upon piling up the woody chips oriented along the longitudinal direction, for example streaks derived from the dividing plates shown in FIG. 1 or a forcing plate such as the orientating plate provided with grooves shown in FIG. 4 can be eliminated. Accordingly, the fourth aspect of the invention is effective when a method of passing the woody chips through grooves formed on the orientating plate shown in FIG. 4 is used as the method of piling up the woody chips oriented along the longitudinal direction thereof.

The manner in which the mat is pressurized is not particularly restricted; for example the mat may be pressurized once in a short time or plural times, or many times in a short time in a vibration-like manner.

The reduction rate of the area of the mat observed from the vertical direction is preferably 5 to 50%. If the reduction rate is less than 5%, the effect of pressurization cannot be achieved, while if the reduction rate is greater than 50%, the longitudinal direction of the woody chips rather tends to be disordered.

In the fourth aspect of the invention, the mat whose area was reduced is finally pressurized and heated from the vertical direction. The pressurization and heating in the fourth aspect of the invention is carried out in the same manner as in the first aspect of the invention except that the direction of pressurization is a vertical direction.

The fifth aspect of the invention is the same as the fourth aspect of the invention except that the method of reducing the area of the mat observed from the vertical direction is different from the method in the fourth aspect of the invention. In the fifth aspect of the invention, a method of passing the mat through 2 plates having a decreasing space there between toward the direction of movement is used as the method of reducing the area of the mat observed from the vertical direction.

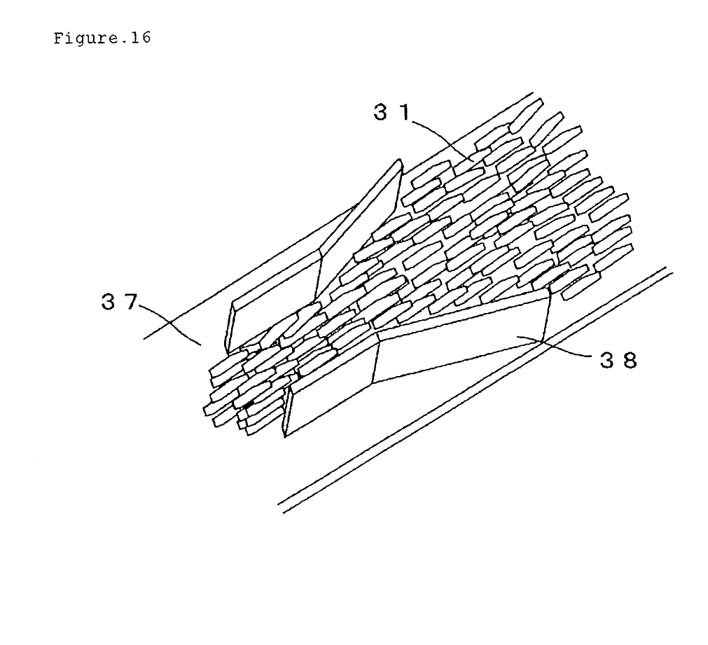

FIG. 16 is a drawing showing a method wherein the area of the mat observed from the vertical direction is reduced by passing the mat through 2 movable plates having a decreasing space there between toward the direction of movement. By passing the mat 37 through two plates 38 having a decreasing space therebetween toward the direction of movement, the bottom area of the mat is reduced and the pressure applied is released upward to the opening, thus pushing the woody chips 31 upward.

The method of reducing the area of the mat observed from the vertical direction, including the two methods described above, may be any methods in which the mat can be pressurized from a direction perpendicular to both the longitudinal direction and vertical direction of the woody chips while the pressure applied can be released upward to an opening.

According to the fourth and fifth aspects of the invention, defects conventionally occurring upon lamination of the woody chips oriented along the longitudinal direction, for example streaks derived from the dividing plates shown in FIG. 1 or a forcing plate such as the orientating plate provided with grooves shown in FIG. 4 can be eliminated. Thus, a reduction in physical properties caused by the streaks are suppressed and a woody composite material having sufficient strength can be produced from woody clips of 15 cm or less in length.

### BEST MODES FOR CARRING OUT THE INVENTION

Hereinafter, this invention is described in more detail by reference to test examples, but this invention is not limited to these test examples.

### TEST EXAMPLE 1

Board chips purchased from a company engaged in disposal of wood wastes were selected with air by a fan, whereby wood chips 1 of 1 to 5 mm in width and 20 to 100 mm in length were separated. The yield was 40% based on the whole of the board chips. Then, the resultant woody chips 1 were molded by the process shown in FIG. 6. First, in the step of blending with a binder (coating with an adhesive), the woody chips 1 and an isocyanate type adhesive as the binder (5parts by weight relative to 100 parts by weight of the woody chips) were introduced into a drum blender 2 and rotated whereby the woody chips were coated with the isocyanate type adhesive.

In the subsequent step of forming a mat, the process shown in FIG. 7 was used wherein the woody chips 4 coated with the binder on the belt conveyer 10 were dropped into an disk orienter 3 with disks arranged at 20 mm intervals, while the longitudinal direction of the chips was oriented along the direction of the production line, whereby the chips were piled up in the guide 8 having internal dimensions of 140 mm in width, 1000 mm in length and 240 mm in height, to form the mat 5 which was then inserted into the horizontal hot pressing unit 6.

In the pressurizing and heating step, the mat 5 was pressurized from the horizontal direction to a width of 40 mm and heated and retained at 180° C. for 1 hour by the horizontal hot pressing unit 6. The dimension of the woody composite material 7 removed after pressurization and heating was a width of 40 mm, a height of 240 mm, and a length of 1000 mm, and the density was 0.70 g/cm³. A sample with an approximately two-by-four section, having a width of 40 mm, a height of 90 mm and a length of 1000 mm, was cut off from the center, in the height direction, of the woody composite material 7 and examined in a bending test in accordance with JIS Z 2101. As shown in Table 1, the measurement results indicated that the bending strength was 35 MPa and the modulus of in bending was 8.1 GPa, and a woody composite material utilizable as a structural material was obtained.

### TEST EXAMPLE 2

A woody composite material was produced in the same manner as in Test Example 1 except that a guide 8 having inner dimensions of 140 mm in width, 1000 mm in length and 600 mm in height was used. The woody chips 4 coated with the binder were piled up in the guide 8 and pressed and heated in the horizontal hot pressing unit 6, to give a woody composite material 7 having a width of 40 mm, a height of 600 mm, a length of 1000 mm and a density of 0.70 g/cm. A sample having an approximately two-by-four section, having a width of 40 mm, a height of 90 mm and a length of 1000 mm was cut off from each of the top and bottom plane of the woody composite material 7 and examined in the same bending test as in Test Example 1

As shown in Table 1, the measurement results indicated that the sample from the top plane had a bending strength of 35 MPa and a modulus of elasticity in bending of 8.2 GPa, while the sample from the bottom plane had a bending strength of 29 MPa and a modulus of elasticity in bending of 7.0 GPa, and both of the samples were in a state utilizable as a structural material, but a reduction in the strength was observed.

### TEST EXAMPLE 3

A woody composite material was produced in the same manner as in Test Example 1 except that a guide 81 having inner dimensions of 140 mm in width, 1000 mm in length and 600 mm in height with dividing plates of 1 mm in thickness arranged at 20-mm intervals was used. The woody chips 4 coated with the binder were piled up in the guide 81 and pressed and heated in the horizontal hot pressing unit 6, to give a woody composite material 7 having a width of 39 mm, a height of 600 mm, a length of 1000 mm and a density of 0.68 g/cm³. A sample having an approximately two-by-four section, having a width of 39 mm, a height of 90 mm and a length of 1000 mm was cut off from each of the top and bottom plane of the woody composite material 7 and examined in the same bending test as in Test Example 1. As shown in Table 1, the measurement results indicated that the sample from the top plane had a bending strength of 34 MPa and a modulus of elasticity in bending of 8.0 GPa, while the sample from the bottom plane had a bending strength of 34 MPa and a modulus of elasticity in bending of 7.9 GPa, and both of the samples were in a state utilizable as a structural material, and a reduction in the strength in the bottom was not observed.

### TEST EXAMPLE 4

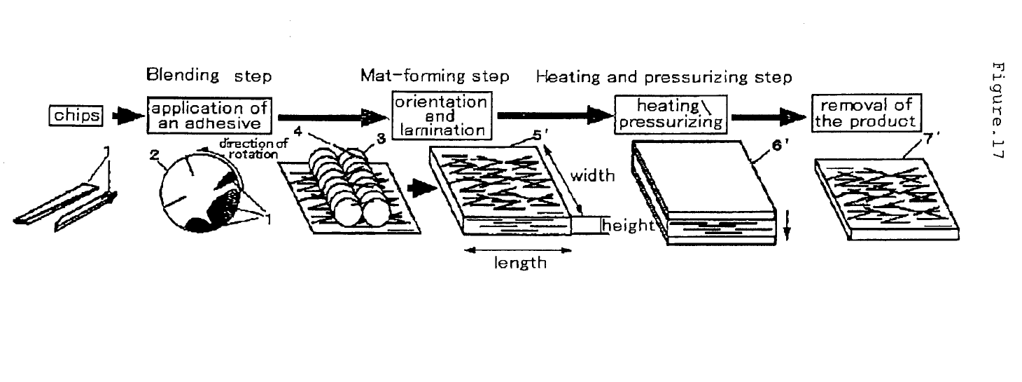

The woody chips 4 coated with the binder, obtained in the sane manner as in Test Example 1, were used to produce a woody composite material in the respective steps shown in FIG. 17. In the step of orientation and lamination, the woody chips were oriented and laminated by the disk orienter 3 to give a mat 5′ having a width of 240 mm, a height of 140 mm and a length of 100 mm. The mat 5′ was pressurized from the vertical direction to a height of 40 mm and heated at 180° C. for 1 hour by a horizontal hot pressing unit 6′. The dimension of the woody composite removed after pressurization and heating was 240 mm in width, 40 mm in height and 1 m in length, and its density was 0.7 g/cm³. A sample having a two-by-four section similar to that in Test Example 1 was cut off and examined in the bending test, and as shown in Table 1, the measurement results indicated that the bending strength was 23 MPa and the modulus of elasticity in bending was 5.2 GPa, and these values were significantly lower than in Test Example 1.

TABLE 1

| | Bending | | Modulus of Elasticity |
|---|---|---|---|
| | Strength (MPa) | | in Bending (GPa) |
| Test Example 1 | | 35 | 8.1 |
| Test Example 2 | top | 35 | 8.2 |
| | bottom | 29 | 7.0 |
| Test Example 3 | top | 34 | 8.0 |
| | bottom | 34 | 7.9 |
| Test Example 4 | | 23 | 5.2 |

### TEST EXAMPLE 5

A woody composite material was prepared in the process shown in FIG. 12.

Specifically, board chips purchased from a company engaged in disposal of wood wastes were classified by a classifying wave roller screen in a wave roller system (produced by Taihei Co., Ltd.), whereby wood chips of 1 to 15 mm in width and 20 to 150 mm in length were obtained. The water content of the woody chips was regulated by a heating oven (50° C., 24 hours) The water content after regulation was 5.2%.

Then, the woody chips whose water content had been regulated and an isocyanate adhesive as the binder were introduced into a drum blender, whereby woody chips consisting of 100 parts by weight of the woody chips coated with 5 parts by weight of the isocyanate adhesive were obtained. Then, the woody chips having the binder adhering thereto were introduced into an OSL forming machine (produced by Taihei Co., Ltd.) and introduced into a guide by the method shown in FIG. 12. The guide used was the one having a length of 2000 mm, a width of 500 mm and a height of 100 mm, and the guide was divided by metallic dividing plates (iron, thickness 2 mm) into 10 equal regions at 50-mm intervals.

Then, the mat obtained by removing the guide as shown in FIG. 12 was introduced into a heat-transfer pressing machine with a mold having a length of 2500 mm, a width of 500 mm and a height of 150 mm (300-ton press, produced by Kawasaki Yuko Co., Ltd.), and the mat was pressurized for 10 minutes at a heating temperature of 180° C. at a pressure of 3 MPa by a press platen such that the final shape of the woody composite material had dimensions of 2000×500×30 mm. Then, all the 6 faces of the resultant woody composite material were finally cut off whereby a plate-shaped woody composite material of 1500×400×25 mm was obtained.

### TEST EXAMPLE 6

A plate-shaped woody composite material of 1500×400×25 mm was obtained in the same manner as in Test Example 5 except that the woody chips with the binder were fed to the respective divided portions via a hopper having an internal shape, with an introducing opening of 100 mm in width and a discharging opening of 30 mm in width, as shown in FIG. 14 in place of the OSL forming machine.

### TEST EXAMPLE 7

A plate-shaped woody composite material of 1500×400×25 mm was obtained in the same manner as in Test Example 6 except that woody chips of 1 to 11 mm in thickness obtained by classification were used, and the interval between the dividing plates in the guide was 25 mm.

### TEST EXAMPLE 8

A plate-shaped woody composite material of 1500×400×25 mm was obtained in the same manner as in Test Example 6 except that woody chips of 3 to 5 mm in thickness obtained by classification were used, and the interval between the dividing plates in the guide was 25 mm.

### TEST EXAMPLE 9

A plate-shaped woody composite, material of 1500×400×25 mm was obtained in the same manner as in Test Example 5 except that a guide not divided with dividing plates was used.

### TEST EXAMPLE 10

A plate-shaped woody composite material of 1500×400×25 mm was obtained in the same manner as in Test Example 5 except that the board chips purchased from a company engaged in disposal of wood wastes were used as woody chips directly without classification.

### TEST EXAMPLE 11

A plate-shaped woody composite material of 1500×400×25 mm was obtained in the same manner as in Test Example 5 except that the board chips purchased from a company engaged in disposal of wood wastes were classified into those having a thickness of 20 mm or more for use as woody chips.

The woody composite materials obtained in Test Examples 5 to 11 were evaluated for their bending strength and modulus of elasticity in bending. The results are shown in Table 2. The bending strength and modulus of elasticity in bending were measured according to JIS Z 2101 .

TABLE 2

| | Bending | Modulus of Elasticity |
|---|---|---|
| | strength (MPa) | in Bending (GPa) |
| Test Example 5 | 25 | 9.2 |
| Test Example 6 | 31 | 10.1 |
| Test Example 7 | 35 | 11.2 |
| Test Example 8 | 38 | 12.0 |
| Test Example 9 | 10 | 2.3 |
| Test Example 10 | 8 | 1.9 |
| Test Example 11 | 12 | 2.5 |

### TEST EXAMPLE 12

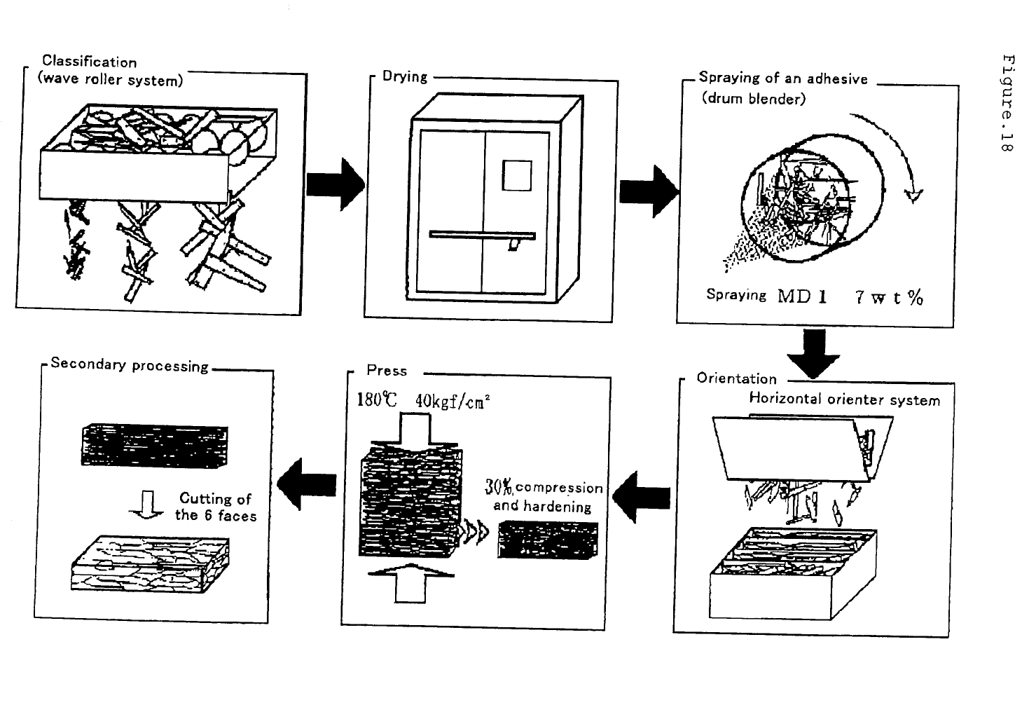

A woody composite material was produced by the process shown in FIG. 18. That is, board chips purchased from a company engaged in disposal of wood wastes were classified by a classifying Wave Roller Screen Machine in a wave roller system (produced by Taihei, Co., Ltd.), to give woody chips of 1 to 15 mm in thickness.

Then, the water content of the classified woody chips was regulated to be constant in a heating oven (50° C., 24 hours). The water content of the woody chips after regulation was 5.2%. Then, the woody chips were introduced into a drum blender, and 100 parts by weight of the woody chips were coated with 5 parts by weight of an isocyanate adhesive as the binder to blend the woody chips with the binder.

Then, the woody chips to which the binder adhered were oriented in the longitudinal direction by the orientating plate provided with grooves shown in FIG. 4, to form a mat, and then the mat was pressurized to a reduction rate of 20% by the device shown in FIG. 15, and the compressed mat was introduced into a pressing machine. The pressing machine used was a heat-transfer300-ton press produced by Kawasaki Yuko Co., Ltd., and the mold used was the one having a length of 2500 mm, a width of 500 mm and a height of 150 mm. The mat was pressed for 10 minutes at a heating temperature of 180° C. at a pressure of 3 MPa by the press platen such that the final shape of the woody composite material had dimensions of 2000×500×30 mm.

All the 6faces of the woody composite material were finally cut off, whereby a woody composite material of 1500×400×25 mm was obtained.

### TEST EXAMPLE 13

A woody composite material was produced in the same manner as in Test Example 12 except that the device shown in FIG. 16 was used in place of the device shown in FIG. 15

### TEST EXAMPLE 14

A woody composite material was produced in the same manner as in Test Example 12 except that the dividing plates shown in FIG. 1 were used in place of the orientating plate shown in FIG. 4.

### TEST EXAMPLE 15

A woody composite material was produced in the same manner as in Test Example 12 except that the device shown in FIG. 15 was not used.

### TEST EXAMPLE 16

A woody composite material was produced in the same manner as in Test Example 12 except that the reduction rate of the mat was 60%.

The woody composite materials obtained in Test Examples 12 to 16 were evaluated for their bending strength and modulus of elasticity in bending, and the results are shown in Table 3. The bending strength and modulus of elasticity in bending were measured according to JIS Z 2101.

TABLE 3

| | Bending | Modulus of Elasticity |
|---|---|---|
| | strength (MPa) | in Bending (GPa) |
| Test Example 12 | 45 | 30 |
| Test Example 13 | 43 | 31 |
| Test Example 14 | 40 | 30 |
| Test Example 15 | 30 | 8 |
| Test Example 16 | 31 | 12 |

### INDUSTRIAL APPLICABILITY

Because the first and second aspects of the invention are constituted as described above, the deviated direction of the woody chips swayed in the mat-forming step can be cancelled and relaxed, and a drop in the strength of the resultant woody composite material can be prevented.

Because the third aspect of the invention is constituted as described above, a mat having woody chips oriented highly accurately in the longitudinal direction can be obtained by molding the mat with a guide, and accordingly, a high-strength woody composite material can also be obtained by pressurization from the vertical direction with a simpler production unit.

Because the fourth and fifth aspects of the invention are constituted as described above, forcing plate-derived streaks on conventional composite materials occurring upon orientation of woody chips along the longitudinal direction can be eliminated, thus a reduction in physical properties caused by the streaks can be suppressed and a reduction in the strength of the resultant composite material can be prevented.

According to this invention, a woody composite material having sufficient strength durable for use as a structural material can be produced even from short woody chips of 15 cm or less in length Accordingly, wastes conventionally disposed of can be effectively utilized, thus reducing the cost for disposal of wastes and preventing environmental pollution caused by combustion of wastes.

1. A process for producing a woody composite material
which comprises the steps comprising
blending woody chips of 1 to 15 cm in length with a binder,
piling up the woody chips so as to be oriented in the longitudinal direction thereof to form a mat, and
pressurizing and heating the mat from a direction perpendicular to both the longitudinal direction and vertical direction of the woody chips.

2. A process for producing a woody composite material
which comprises the steps comprising
blending woody chips of 1 to 15 cm in length with a binder,
piling up the woody chips so as to be oriented in the longitudinal direction thereof to form a mat, and
rotating the mat by 90° rightward or leftward around the longitudinal direction of the woody chips as the axis of rotation and then pressurizing and heating the mat from the vertical direction.

3. A process for producing a woody composite material
which comprises the steps comprising
blending woody chips of 1 to 15 cm in length with a binder,
piling up the woody chips to a predetermined height while orienting them in the longitudinal direction thereof in the inside of a guide arranged so as to regulate the outside of the woody chips in a direction perpendicular to both of the longitudinal direction and vertical direction of the woody chips, to form a mat, and
removing the guide and then pressurizing and heating the mat from the vertical direction.

4. The process for producing a woody composite material according to claim 3,
wherein the guide is divided by plates into 2 or more regions.

5. A process for producing a woody composite material
which comprises the steps comprising
blending woody chips of 1 to 15 cm in length with a binder,
piling up the woody chips so as to be oriented in the longitudinal direction thereof to form a mat,
pinching the mat with 2 movable plates from a direction perpendicular to both the longitudinal direction and vertical direction of the woody chips and then pressurizing the mat with the plates while pushing the woody chips upward, to reduce the area of the mat observed from the vertical direction, and
pressurizing and heating, from the vertical direction, the mat of which area was reduced when observed from the vertical direction.

6. A process for producing a woody composite material
which comprises the steps comprising
blending woody chips of 1 to 15 cm in length with a binder,
piling up the woody chips so as to be oriented in the longitudinal direction thereof to form a mat, and
passing the mat through 2 plates having a decreasing space therebetween toward the direction of movement while pushing the woody chips upward, to reduce the area of the mat observed from the vertical direction, and
pressurizing and heating, from the vertical direction, the mat of which area was reduced when observed from the vertical direction.

7. The process for producing a woody composite material according to claim 5 or 6,
wherein the woody chips are piled up so as to be oriented in the longitudinal direction thereof by passing the woody chips through grooves in an orientating plate having the grooves formed thereon.
